(19) United States
(12) Patent Application Publication
(10) Pub. No.: US 2004/0085213 A1
(43) Pub. Date: May 6, 2004

(54) Wrist time device with function of environmental status delecting/informing

(76) Inventor: Yuan Sung Weng, Taipei (TW)

Correspondence Address: BUCKNAM AND ARCHER, 1077 NORTHERN BOULEVARD, ROSLYN, NY, 11576, US

(21) Appl. No.: 10/663,466

(22) Filed: Sep. 16, 2003

(30) Foreign Application Priority Data
Oct. 25, 2002 (TW) 091217105

(51) Int. Cl. G08B 17/10

(52) U.S. Cl. 340/632

(57) ABSTRACT

The invention provides a wrist time device with function of environmental status detecting/informing, comprising a case for demarcating a space accommodated therein: a control circuit unit; a display unit; a memory unit; an input unit; a timer unit; a battery; a micro gases/molecules detector unit; and a spectral identification unit, so that such a device can thereby sustain a long-term use and provide the user with information about the environmental status in order to achieve warning and protection efficacy for user anywhere and anytime.

### BACKGROUND

1. Field of the Invention

The present invention relates to a wrist time device with function of environmental status detecting/informing, especially to a wrist time device with function of detecting/informing for specific gases or molecules in the environment so as to inform the user with the existence of such materials and to provide safety alert.

2. Related Art of the Invention

Due to highly developed industrialization of metropolis, there are increasing gas pollutant in the surrounding environment and such chronically static pollution have already caused vital hazard to the beings.

However, colorless and odorless disasters occurred in acute dynamic pollution situations such as gas leak of home appliance and gas/exhaust gas leak of industrial application frequently result in massive damage without warning. Particularly, accidents such as marsh gas poisoning encountered by sewer worker or chlorine leak in chemical plant usually cause death and is hard to escape in time due to the overwhelmed gas capable of fast invasion into human body.

Therefore, there is necessary to develop an easy-to-put-on device capable of providing detecting/informing of environmental status such as deleterious gases/molecules while has the advantage of thin, compact and light-weighted with a popular price. Such device can sustain a long-term use and provide the user with information about the environmental status so as to achieve warning and protection to user anywhere and anytime.

### SUMMARY OF THE INVENTION

Therefore, an object of the present invention is to provide a wrist time device with function of environmental status detecting/ informing, which is capable of detecting specific gases/molecules in the environment and provides the user with information about the existence of such deleterious gases/molecules so as to achieve warning and protection to user anywhere and anytime.

To achieve the object, a wrist time device for detecting deleterious gases/molecules and displaying time/data provided in accordance with one aspect of the present invention, comprising a case for demarcating a space accommodated therein: a control circuit unit, for processing data and time in accordance with a control signal and controlling the operation of each of members; a display unit, for displaying the data and time; a memory unit, for pre-storing the spectra of specific gases/molecules; an input unit, for input of the control signal to the control circuit unit to allow the control circuit unit to process the data and control the operation of each of members based on the control signal; a timer unit, for providing time; a battery, for providing working voltage to each member; a micro gases/molecules detection unit, for performing real-time detection of gases/molecules flew in from the surrounding and generating spectra corresponding the gases/molecules; and a spectra identification unit, for identifying the detected spectra of said gases/molecules based on the pre-stored spectra of specific gases/molecules and displaying data whenever there is a match.

In another aspect of the present invention, the wrist time device further comprises a put-on device such as watchband, necklace and the like for easy to carry along.

Further, in above aspects of the present invention, the wrist time device is used to display data including the name and concentration of the detected gases/molecules, and the data includes the name and concentration of the detected gases/molecules.

In still another aspect of present invention, the wrist time device of present invention further comprises a beeper for beeping whenever the detected spectra of the gases/molecules match the pre-stored spectra of specific gases/molecules.

Furthermore, in above aspects of the present invention, said specific gases/molecules includes volatile organic gas (VOCs), gas, marsh gas, methane (CH₄), hydrochloride (HCl), chlorine (Cl₂), carbon oxide (CO), hydrosulfur (H₂S), sulfate (H₂SO₄), oxynitride (NOₓ), Dioxin, and at least one substance selected from a group of similar materials.

Furthermore, in above aspects of the present invention, the wrist time device comprises a timer for showing a time and an accumulated time of detecting said gases/molecules.

Furthermore, in above aspects of the present invention, the display unit is a liquid crystal display.

In yet another aspect of the present invention, the wrist time device further comprises a transmitting interface unit connected to the input unit for connecting with other devices such as personal computer(PC), personal data assistant(PDA) and the like for further data processing.

Furthermore, in above aspects of the present invention, the transmitting interface unit is an infrared transmitter/receiver or other type of transmitter/receiver capable of performing bi-directional data transmission.

### BRIEF DESCRIPTION OF DRAWINGS

The above and other objects, features, and advantages of the present invention will become more apparent from the detailed description in conjunction with the following drawings, wherein:

FIG. 1 is a block diagram schematically showing the structure of a wrist time device with function of environmental status detecting/informing in accordance with a preferred embodiment of the present invention;

FIG. 2 is a schematic view showing a product made in accordance with the preferred embodiment of the present invention; and

FIG. 3 is a flow chart showing the operation process of the preferred embodiment of the present invention.

### DETAILED DESCRIPTION OF THE INVENTION

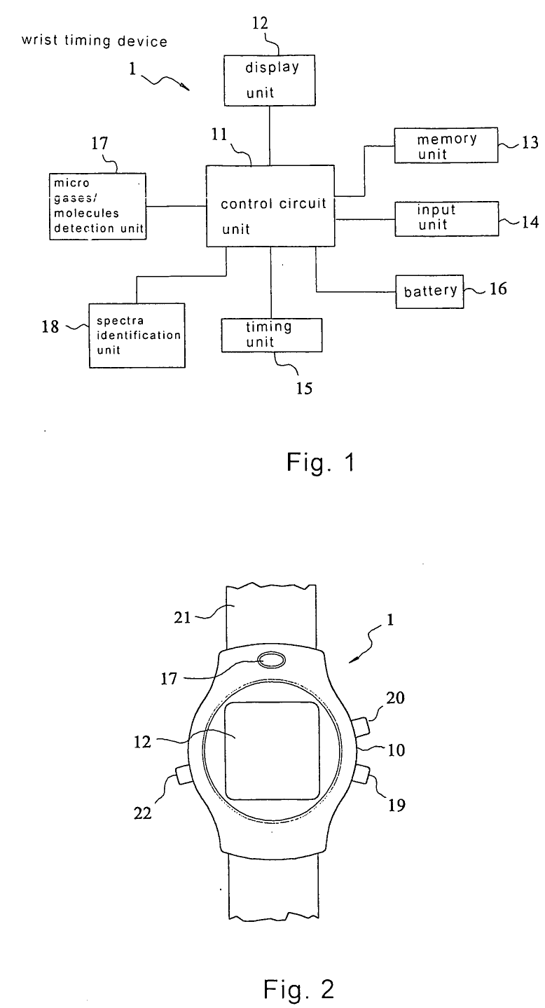

Referring to FIG. 1 and FIG. 2, FIG. 1 is a block diagram schematically showing a structure of a wrist time device with function of environmental status detecting/informing in accordance with a preferred embodiment of present invention, and FIG. 2 is a schematic view showing a product made in accordance with the preferred embodiment of the present invention, respectively. The wrist time device 1 comprises a case 10, which contains a control circuit unit 11; a display unit 12; a memory unit 13; an input unit 14; a timer unit 15; a battery 16; a gases/molecules detection unit 17; and a spectra identification unit 18.

As shown in the figures, the control circuit unit 11 operates to process data and time as well as to control the operation of each member. The memory unit 13 pre-stores the spectra of specific gases/molecules such as volatile organic gas (VOCs), gas, marsh gas, methane (CH₄), hydrochloride (HCl), chlorine (Cl₂), carbon oxide (CO), hydrosulfur (H₂S), sulfate (H₂SO₄), oxynitride (NOₓ), Dioxin, and at least one substance selected from a group of similar materials. The input unit 14 allows the user to input a control signal to the control circuit unit 11 via a control button 20, so that the control circuit unit 11 may operate to process the data, to display the time and to control the operation of each member in accordance with the selected mode confirmed by a select button 19. Furthermore, except directly inputting an instruction or command via the control button 20 and select button 19 of the input unit 14, the user may also use a transmitting interface unit, which is capable of performing bidirectional data transmission and connected to other devices such as personal computer (PC), personal data assistant (PDA) and the like to perform further data analysis and storage.

The display unit 12 is a display, such as liquid crystal display, used to display time and data through the control of said control circuit unit 11 via the select button 19. The timer 15 provides time and elapse time on the display unit 12 through the control circuit unit 11. The battery 16 supplies working voltage to each member so as to conduct the corresponding function.

According to the present invention, the wrist time device 1 comprises a micro gases/molecules detection unit 17 for performing real-time detection of gases/molecules flew in from the surrounding, that is to say, it is possible to detect ultra minute amount (e.g., ppm) of sample gas by means of a direct-read detector.

However, the present invention is not limited to above sampling method but can also be an absorptive sampling method, in which an IC chip of detection unit operates to generate various current when there are gases/molecules flew in from the surrounding, and then transforms such current into the spectra of the gases/molecules by means of a Fourrier transform infrared (FTIR) interferometer or an differential optical absorptive spectroscopy (DOAS) of prior art. Subsequently, the spectra identification unit 18 identifies the spectra based on the pre-stored spectra of specific gases/molecules and displays data such as the name and concentration of the specific gases/molecules on the display unit 12 whenever there is a match. Optionally, the concentration can be expressed as a detection mode of elapse time and displayed correspondingly.

Besides, the wrist time device further comprises a put-on device 21 such as watchband, necklace and the like. An example of watchband is shown in FIG. 2; however, the present invention is not limited to this.

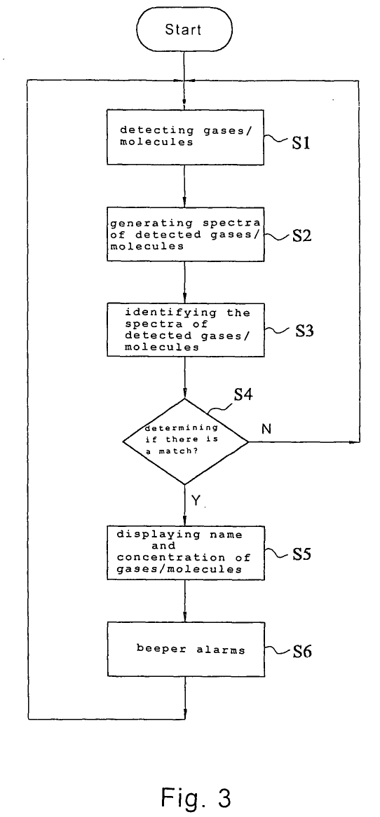

FIG. 3 is a flow chart showing the operation process of the preferred embodiment of the present invention, in which only the operation of the wrist time device with function of environmental status detecting/informing is included, the operation of timer is familiar to those skilled in prior art and will be omitted. Initially, the micro gases/molecules detection unit 17 of the wrist time device 1 detects gases/molecules in the surrounding area in step S1; generates the spectra of detected gases/molecules based on the concentration or current of the detected gases/molecules in step S2; then identifies the spectra of detected gases/molecules based on the spectra of specific gases/molecules pre-stored in the memory unit 13 in step S3; and subsequently determines whether there is a match in step S4, if there is no match, the procedure returns to step S1, while if there is a match, the procedure proceeds to step S5; displays the name and concentration of the identified gases/molecules on the display unit 12 in step S5; the beeper is activated for alerting when the concentration of said gases/molecules is higher than a pre-determined level until the reset key (denoted as 22 in FIG. 2) is pressed by the user; finally, the procedure again returns to step S1 to start another detecting/informing operation.

As described above, since there are deleterious gases/molecules and allergic elements (e.g., some specific gases/molecules) everywhere in the surroundings, it is advantageous that a wrist time device with function of environmental status detecting/ informing in accordance with present invention provides the safe and healthy protection of a user from deleterious gases/molecules in the environment, in which the micro gases/molecules detection unit will be activated by the surrounding gases/molecules flew into the wrist time device, while an IC chip of said detector operates to generate various current and transform such current into the spectra of said gases/molecules based on the variation of voltage supplied thereon by applying a bias, a spectra identification unit will then identify the spectra based on the pre-stored spectra of specific gases/molecules and display data such as the name and concentration of the specific gases/molecules whenever there is a match and activate a beeper to warn the user of the existence of deleterious gases/molecules.

However, above described is a preferred embodiment of present invention. Those who skilled in prior technique should understand that present invention is not limited to above description and various modifications and changes in accordance with claims given below are considered to fall within the spirit and scope of present invention.

### List of Reference Numerals

1 wrist timing device

10 case

11 control circuit unit

12 display unit

13 memory unit

14 input unit

15 timing unit

16 battery

17 micro gases/molecules detection unit

18 spectra identification unit

19 select button

20 control button

21 put-on device

22 reset key

What is claimed is:

1. A wrist time device, for detecting deleterious gases/molecules and displaying time/data, comprising a case for demarcating a space accommodated therein:
a control circuit unit, for processing data and time in accordance with a control signal and controlling operation of each members;
a display unit, for displaying said data and time;
a memory unit, for pre-storing spectra of specific gases/molecules;
an input unit, for input of the control signal to the control circuit unit to allow the control circuit unit to process the data and control the operation of each of members based on the control signal;
a timer unit, for providing time;
a battery, for providing working voltage to each member;
a micro gases/molecules detection unit, for performing real-time detection of gases/molecules flew in from the surrounding and generating spectra corresponding the gases/molecules; and
a spectra identification unit, for identifying the detected spectra of said gases/molecules based on the pre-stored spectra of specific gases/molecules and displaying data whenever there is a match.

2. The wrist time device as set forth in claim 1, further comprises a put-on device which is a watchband, necklace and the like for easy to carry along.

3. The wrist time device as set forth in claim 1, in which said data includes the name and concentration of said detected gases/molecules.

4. The wrist time device as set forth in claim 1, further comprises a beeper for beeping whenever the detected spectra of said gases/molecules match the pre-stored spectra of specific gases/molecules.

5. The wrist time device as set forth in claim 1, in which said timer provides a time and an accumulated time of gases/molecules detection.

6. The wrist time device as set forth in claim 1, in which said display unit is a liquid crystal display.

7. The wrist time device as set forth in claim 1, further comprises a transmitting interface unit connected to said input unit so as to connect to other devices including personal computer, personal data assistant and the like for further data processing.

8. The wrist time device as set forth in claim 1, in which said transmitting interface unit is an infrared transmitter/receiver or other type of transmitter/receiver capable of performing bidirectional data transmission.

9. The wrist time device as set forth in claim 1, in which said specific gases/molecules includes volatile organic gas (VOCs), gas, marsh gas, methane (CH₄), hydrochloride (HCl), chlorine (Cl₂), carbon oxide (CO), hydrosulfur (H₂S), sulfate (H₂SO₄), oxynitride (NOₓ), Dioxin, and at least one substance selected from a group of similar materials.

10. The wrist time device as set forth in claim 1, in which said spectra of detected gases/molecules is generated by means of a Fourrier transform infrared (FTIR) interferometer or an differential optical absorptive spectroscopy (DOAS).
